(19) United States
(12) Patent Application Publication
(10) Pub. No.: US 2021/0225373 A1
(43) Pub. Date: Jul. 22, 2021

(54) VOICE CONTROL METHOD, DEVICE AND STORAGE MEDIUM

(71) Applicant: HONG FU JIN PRECISION INDUSTRY (WuHan) CO., LTD., Wuhan (CN)

(72) Inventors: MI SHI, Wuhan (CN); ZHI-YONG ZHAO, Shenzhen (CN); TAI-CHEN WANG, New Taipei (TW)

(21) Appl. No.: 17/033,840

(22) Filed: Sep. 27, 2020

Related U.S. Application Data
(63) Continuation-in-part of application No. PCT/CN2020/073299, filed on Jan. 20, 2020.

(51) Int. Cl. G10L 15/22; G10L 15/08

(52) U.S. Cl. CPC G10L 15/22; G10L 2015/223; G10L 2015/088; G10L 15/08

(57) ABSTRACT

A voice control method includes obtaining a voice command; analyzing the voice commands and generating a control instruction based on the voice command; and transmitting the control instruction to a test device, wherein the control instruction is configured to control the test device to perform corresponding actions.

### FIELD

The subject matter herein generally relates to testing technology, and especially to a voice control method, device, and a storage medium.

### BACKGROUND

In the manufacturing process of electronic devices, such as mobile phones, it is usually necessary to use test equipment to test their functions. At present, testers usually operate the test equipment manually. When their hands are occupied to find points, weld ground wires, and use probe rods to contact the measured points to lead out signals, it is impossible to carry out multiple test operations. Therefore, the test efficiency is low.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates an embodiment of a schematic structural diagram of a test system.

FIG. 2 illustrates an embodiment of a schematic structural diagram of a voice control device.

FIG. 3 illustrates an embodiment of a schematic structural diagram of a voice control system.

FIG. 4 illustrates an embodiment of a flowchart of a voice control method, the method including a block 53.

FIG. 5 illustrates an embodiment of a flowchart of the block 53.

### DETAILED DESCRIPTION

In order to provide a clear understanding of the objects, features, and advantages of the present disclosure, the same is given with reference to the drawings and specific embodiments. It should be noted that non-conflicting embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives.

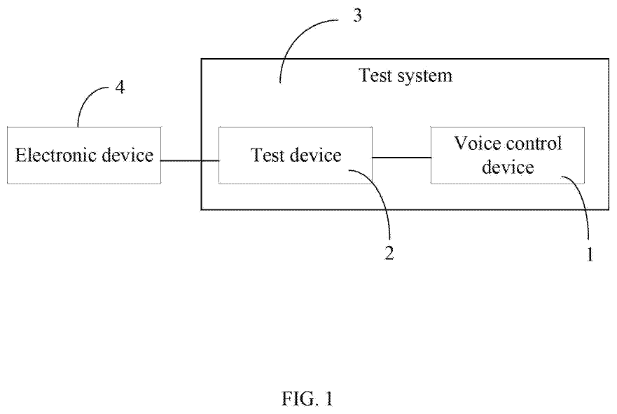

FIG. 1 illustrates an embodiment of a schematic structural diagram of a test system. The test system 3 includes a voice control device 1 and a test device 2. The voice control device 1 is configured to obtain voice commands, analyze the voice commands to generate control instructions and transmit the control instructions to the test device 2. The control instructions are configured to control the test device 2 to perform corresponding actions to test an electronic device 4.

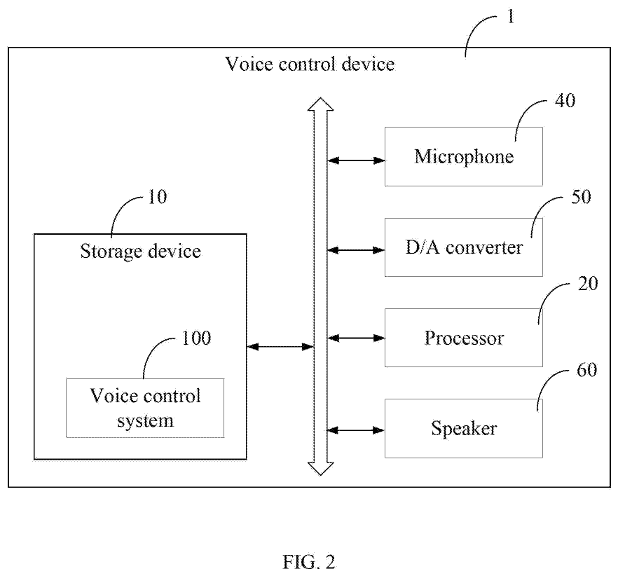

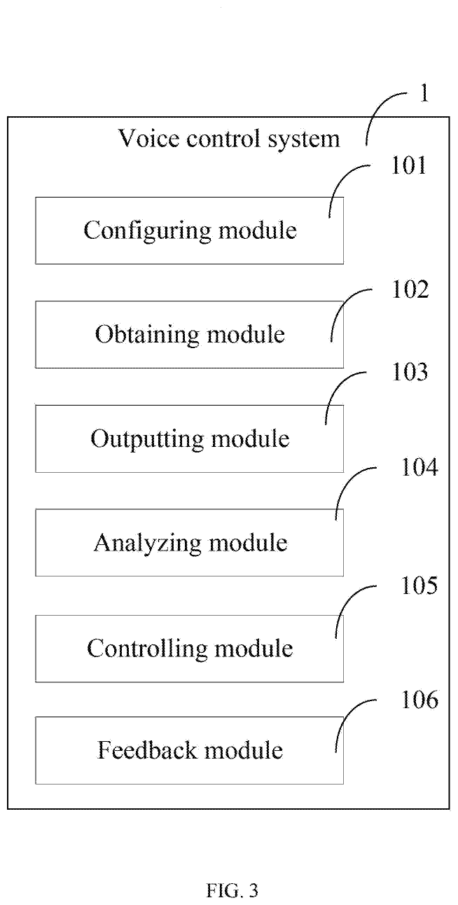

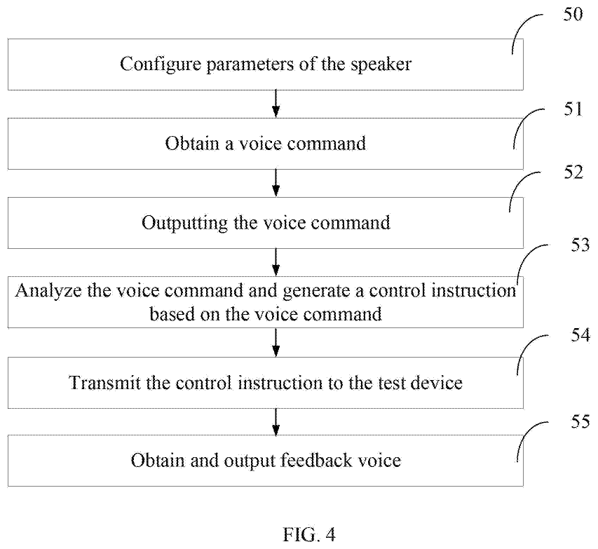

Referring to FIG. 2, a voice control system of an embodiment is illustrated. The voice control device 1 includes a storage device 10, a processor 20, a voice control system 100 stored in the storage device 10 and configured to be performed by the processor 20, a microphone 40, a D/A converter 50, and a speaker 60. The voice control system 100 can be in a form of a computer program. The computer program may be executed by the processor 20 to perform steps of a voice control method of embodiments, such as blocks 50-55 in FIG. 4. Or, the computer program may be executed by the processor 20 to implement functions of modules of the voice control system of embodiments, such as modules 101-106 in FIG. 3.

The voice control system 100 can include one or more functional modules that may be stored in the storage device 10 and executed by the processor 20. The one or more functional modules consist of program code segments that can be executed to implement one or more functions. In at least one embodiment, the voice control system 100 can include a plurality of modules. The plurality of modules can include, but is not limited to, a configuring module 101, an obtaining module 102, an outputting module 103, an analyzing module 104, a controlling module 105, and a feedback module 106. The modules 101-106 can be described in detail in embodiments of the voice control system 100.

The voice control device 1 can communicate with the test device 2 in a wired or wireless manner, thus controlling the test device 2 by transmitting control instructions to the test device 2. It can be understood by those skilled in the art that the schematic diagram is merely an example of the voice control device 1, it does not constitute a limitation of the voice control device 1, other examples may include more or fewer components than those illustrated, or combine some components, or different components. For example, the voice control device 1 may further include a network access device, a bus, and the like.

In at least one embodiment, the test device 2 may be a computer. The electronic device 4 can be a mobile phone. The voice control device 1 controls the test device 2 to test the electronic device 4.

In some embodiments, the processor 20 may be a central processing unit (CPU), and other general-purpose processors, digital signal processors (DSPs), application specific integrated circuits (ASICs), and off-the-shelf programmable gate arrays, Field-Programmable Gate Array (FPGA), or another programmable logic device, discrete gate, or transistor logic device, discrete hardware components, etc. The general-purpose processor may be a microprocessor or the processor may be any conventional processor or the like. The processor 20 is a control center of the voice control device 1 and connects components of the voice control device 1 with various interfaces and lines.

In some embodiments, the storage device 10 can be used to store program codes of computer-readable programs and various data, such as the voice control system 100. The processor 20 executes the voice control system 100 and reads data stored in the storage device 10 to implement functions of the voice control device 1. The storage device 10 can include a read-only memory (ROM), a random access memory (RAM), a programmable read-only memory (PROM), an erasable programmable read-only memory (EPROM), a one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the voice control device 1 including smart media cards (SMC), secure digital (SD) cards, and flash cards.

FIG. 3 illustrates functional modules of the voice control system according to an embodiment.

Referring to FIG. 3, the voice control system 100 may include the configuring module 101, the obtaining module 102, the outputting module 103, the analyzing module 104, the controlling module 105, and the feedback module 106. It can be understood that in other embodiments, the aforementioned modules may also be program instructions or firmware (firmware) solidified in the processor 20.

The configuring module 101 is configured to configure parameters of the speaker 60. The parameters may include, but are not limited to, open/close the speaker 60 and the volume of the speaker 60. The obtaining module 102 is configured to obtain one or more voice commands. The outputting module 103 is configured to output the one or more voice commands according to the parameters. The analyzing module 104 is configured to analyze the one or more voice commands and generate one or more control instructions based on the one or more voice commands. The controlling module 105 is configured to transmit the one or more control instructions to the test device 2 to control the test device 2 to perform corresponding actions. The feedback module 106 is configured to output feedback voice according to a state how the control instructions are performed. Based on the feedback voice, a user can know whether the control instructions are transmitted successfully.

FIG. 4 illustrates an embodiment of a flowchart of a voice control method. Each block shown in FIG. 4 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The voice control method may begin at block 50.

At block 50, the configuring module 101 configures parameters of the speaker 60. In at least one embodiment, the parameters may include open/close the speaker 60 and a volume of the speaker 60.

At block 51, the obtaining module 102 obtains one or more voice commands.

In at least one embodiment, the microphone 40 captures a user's voice, and the D/A converter 50 converts analog voice signal to digital signal by performing A/D conversion to obtain a voice command. The obtaining module 102 obtains the voice command from the D/A converter 50.

At block 52, the outputting module 103 outputs the voice command.

It should be understood that, if the voice control system 100 is configured the parameter of the speaker 60 to be open the speaker 60, block 52 can be performed. If the voice control system 100 is configured the parameter of the speaker 60 to be close the speaker 60, block 52 may be omitted and the process goes to block 53.

At block 53, the analyzing module 104 analyzes the voice command and generates at least one control instruction based on the voice command.

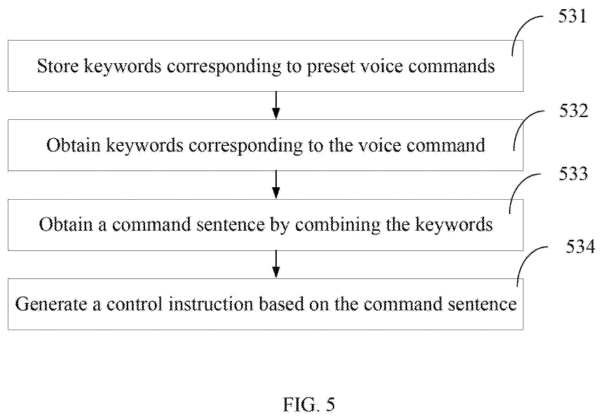

Referring also to FIG. 5, analyzing the voice commands may include:

At Block 531, the analyzing module 104 storing a plurality of keywords corresponding to a plurality of preset voice commands to a database. The keywords may include test related keywords, for example, start a computer, open a command prompt (CMD), confirm, repeat testing, quick assignment, and so on.

At block 532, the analyzing module 104 matches the voice command to the preset voice commands stored in the database to obtain one or more keywords corresponding to the voice command. If there isn't a preset voice command corresponding to the voice commands, the voice commands are discarded. If there are one or more present voice commands corresponding to the voice command, the voice command is stored into the storage device 10. In at least one embodiment, the voice commands may be corresponding to two or more keywords.

At block 533, the analyzing module 104 generates at least one command sentence.

In at least one embodiment, each of the keywords stored in the database has a corresponding ID, the command sentence can be obtained by combining the keywords according to an order of the ID of each keyword corresponding to the voice commands. For example, the keywords may include, 001 representing start a computer, 002 representing open the command prompt (CMD), 003 representing conform, 004 representing repeat testing, 005 representing quick assignment. The voice commands may be corresponding to two or more keywords. For example, the two or more keywords may include, 001 representing start a computer, 002 representing open the command prompt (CMD), 003 representing conform. The command sentence corresponding to the voice commands can be “start a computer”, “open a command prompt”, and “confirm by combining the keywords 001, 002 and 003”.

In at least one embodiment, the analyzing module 104 combines the keywords in an order in which the keywords occur in the voice command. For example, the voice command includes three keywords occuring in sequence. The three keywords are respectively 001, 002 and 003. Therefore, the command sentence can be “start a computer”, “open a command prompt”, and “confirm by combining the keywords 001, 002 and 003” according to an order in which the keywords occur in the voice command.

At block 534, the analyzing module 104 generates a command instruction based on the command sentence.

Block 54, the controlling module 105 transmits the control instruction to the test device 2 to control the test device 2 to perform corresponding actions to test the electronic device 4.

In at least one embodiment, the database stores feedback voice corresponding to keywords. For example, the keyword “start a computer” is corresponding to two kinds of feedback voice: one refers to start the computer successfully, the other one refers to fail to start the computer. The keyword “open the command prompt” is corresponding to two kinds of feedback voice: one is to open the command prompt successfully, the other one is to fail to open the command prompt successfully.

In at least one embodiment, the feedback module 106 obtains feedback voice according to a state how the control instruction is performed and outputs the feedback voice (block 55). A user can quickly know the state how the control instruction is performed based on the feedback voice.

The voice control device, method and storage medium can obtain voice commands, analyze the voice commands to generate control instructions, and transmit the control instructions to the test device to control the test device to perform actions to test the electronic device. That is, the voice control device can control the test device to test the electronic device automatically without human involvement.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A voice control method, comprising:
obtaining a voice command;
analyzing the voice commands and generating a control instruction based on the voice command; and
transmitting the control instruction to a test device, wherein the control instruction is configured to control the test device to perform corresponding actions.

2. The method according to claim 1, wherein analyzing the voice commands comprising:
storing keywords in a database, wherein each keyword is corresponding to a preset voice command; and
obtaining one or more keywords corresponding to the voice commands by matching the voice command to the preset voice command;
obtaining a command sentence based on the one or more keywords corresponding to the voice commands; and
generating the control instruction based on the command sentence.

3. The method according to claim 2, wherein each of the keywords stored in the database has an ID, generating the control instruction based on the command sentence comprises combining the keywords corresponding to the voice command according to an order of the ID of each keyword if there are two or more keywords corresponding to the voice command.

4. The method according to claim 2, wherein generating the control instruction based on the command sentence comprises combining the keywords corresponding to the voice command according to an order in which each keyword occurs in the voice command.

5. The method according to claim 1, further comprising outputting the voice command by a speaker.

6. The method according to claim 5, further comprising configuring parameters of the speaker, and the voice command is outputted based on the parameters of the speaker.

7. The method according to claim 2, further comprising:
obtaining a feedback voice according to a state how the control instruction is performed; and
outputting the feedback voice.

8. A voice control device, comprising:
a microphone, configured to capture user's voice;
a processor; and
a storage device, storing one or more programs, which when executed by the processor, cause the processor to:
obtain a voice command;
analyze the voice commands and generate a control instruction based on the voice command; and
transmit the control instruction to a test device, wherein the control instruction is configured to control the test device to perform corresponding actions.

9. The voice control device according to claim 8, wherein analyzing the voice commands comprising:
storing keywords in a database, wherein each keyword is corresponding to a preset voice command; and
obtaining one or more keywords corresponding to the voice commands by matching the voice command to the preset voice command;
obtaining a command sentence based on the one or more keywords corresponding to the voice commands; and
generating the control instruction based on the command sentence.

10. The voice control device according to claim 9, wherein each of the keywords stored in the data base has an ID, generating the control instruction based on the command sentence comprises combining the keywords corresponding to the voice command according to an order of the ID of each keyword if there are two or more keywords corresponding to the voice command.

11. The voice control device according to claim 9, wherein generating the control instruction based on the command sentence comprises ombining the keywords corresponding to the voice command according to an order in which each keyword occurs in the voice command.

12. The voice control device according to claim 8, wherein the one or more programs further cause the processor to output the voice command by a speaker.

13. The voice control device according to claim 12, wherein the one or more programs further cause the processor to configure parameters of the speaker, and the voice command is outputted based on the parameters of the speaker.

14. The voice control device according to claim 9, wherein the one or more programs further cause the processor to:
obtain a feedback voice according to a state how the control instruction is performed; and
output the feedback voice.

15. A non-transitory storage medium having stored thereon instructions that, when executed by a processor of a voice control device, causes the processor to perform a voice control method, the method comprising:
obtaining a voice command;
analyzing the voice commands and generating a control instruction based on the voice command; and
transmitting the control instruction to a test device, wherein the control instruction is configured to control the test device to perform corresponding actions.

16. The non-transitory storage medium according to claim 15, wherein analyzing the voice commands comprising:
storing keywords in a database, wherein each keyword is corresponding to a preset voice command; and
obtaining one or more keywords corresponding to the voice commands by matching the voice command to the preset voice command;
obtaining a command sentence based on the one or more keywords corresponding to the voice commands; and
generating the control instruction based on the command sentence.

17. The non-transitory storage medium according to claim 16, wherein each of the keywords stored in the data base has an ID, generating the control instruction based on the command sentence include combining the keywords corresponding to the voice command according to an order of the ID of each keyword if there are two or more keywords corresponding to the voice command.

18. The non-transitory storage medium according to claim 15, wherein generating the control instruction based on the command sentence comprises ombining the keywords corresponding to the voice command according to an order in which each keyword occurs in the voice command.

19. The non-transitory storage medium according to claim 15, further comprising outputting the voice command by a speaker.

20. The non-transitory storage medium according to claim 19, further comprising configuring parameters of the speaker, wherein the voice command is outputted based on the parameters of the speaker.
